(19) United States
(12) Patent Application Publication
(10) Pub. No.: US 2026/0145676 A1
(43) Pub. Date: May 28, 2026

(54) VEHICLE AND METHOD FOR CONTROLLING THE SAME

(71) Applicants: Hyundai Motor Company, Seoul (KR); Kia Corporation, Seoul (KR)

(72) Inventors: In Ho KIM, Hwaseong-Si (KR); Eun JEONG, Hwaseong-Si (KR); Tae Jun LEE, Hwaseong-Si (KR); Jae Woong KOH, Hwaseong-Si (KR); In Ho CHOI, Hwaseong-Si (KR); Chi Hong PARK, Hwaseong-Si (KR); Ik Hyeon AN, Hwaseong-Si (KR); Seung Geon MOON, Hwaseong-Si (KR); Se Hee KIM, Hwaseong-Si (KR)

(21) Appl. No.: 19/364,210

(22) Filed: Oct. 21, 2025

(30) Foreign Application Priority Data
Nov. 22, 2024 (KR) 10-2024-0168011

(51) Int. Cl. B60W 30/14; B60W 50/00; B60W 60/00

(52) U.S. Cl. CPC B60W 30/143; B60W 50/00; B60W 60/001; B60W 2050/0005; B60W 2555/60; B60W 2556/10

(57) ABSTRACT

A vehicle and a method for controlling the same are disclosed. A method performed by an apparatus of a vehicle may include: receiving first point-to-point speed enforcement information associated with a first point-to-point speed enforcement section of a road; controlling, based on first the point-to-point speed enforcement information, one or more first autonomous driving operations of the vehicle while the vehicle travels in the first point-to-point speed enforcement section; detecting a rerouting event associated with the vehicle; determining, based on whether the vehicle is in the first point-to-point speed enforcement section after completion of the rerouting event, whether to reuse the first point-to-point speed enforcement information; and controlling, based on the determining of whether to reuse the first point-to-point speed enforcement information, one or more second autonomous driving operations of the vehicle.

### CROSS-REFERENCE TO RELATED APPLICATION

This application claims priority to Korean Patent Application No. 10-2024-0168011, filed on Nov. 22, 2024, the disclosure of which is incorporated herein by reference in its entirety.

### FIELD

The present disclosure relates to controlling driving operations of a vehicle.

### BACKGROUND

Point-to-point speed enforcement control technology allows a vehicle to comply with a speed limit in a specific section. In a point-to-point speed enforcement section, a vehicle may be required to drive while keeping an average speed, while passing through the entire section, within a speed limit. Thus, speed control in such a section may need to be performed in consideration of the driving distance between a start point and an end point of the point-to-point speed enforcement section, as well as time.

The matters described in this Background section are only for enhancement of understanding of the background of the disclosure, and should not be taken as acknowledgment that they correspond to prior art already known to those skilled in the art.

### SUMMARY

The present disclosure has been made to solve the aforementioned problems, and is directed to maintaining the continuity of point-to-point speed enforcement information by inheriting existing driving information when a vehicle is in the same section as an existing point-to-point speed enforcement section even when rerouting occurs.

The problems to be solved by the present disclosure are not limited to the problems mentioned above, and other problems that are not mentioned can be clearly understood by those skilled in the art from the description below.

According to one or more example embodiments of the present disclosure, a method performed by an apparatus of a vehicle may include: receiving first point-to-point speed enforcement information associated with a first point-to-point speed enforcement section of a road; controlling, based on first the point-to-point speed enforcement information, one or more first autonomous driving operations of the vehicle while the vehicle travels in the first point-to-point speed enforcement section; detecting a rerouting event associated with the vehicle; determining, based on whether the vehicle is in the first point-to-point speed enforcement section after completion of the rerouting event, whether to reuse the first point-to-point speed enforcement information; and controlling, based on the determining of whether to reuse the first point-to-point speed enforcement information, one or more second autonomous driving operations of the vehicle.

The method may further include: receiving, based on determining that the vehicle is in the first point-to-point speed enforcement section after completion of the rerouting event, updated first point-to-point speed enforcement information associated with a remainder of the first point-to-point speed enforcement section. The updated first point-to-point speed enforcement information may include at least some of the first point-to-point speed enforcement information. Controlling the one or more second autonomous driving operations of the vehicle may include: controlling, based on the updated first point-to-point speed enforcement information, the one or more second autonomous driving operations of the vehicle while the vehicle travels in the remainder of the first point-to-point speed enforcement section.

The updated first point-to-point speed enforcement information may indicate at least one of: a speed limit of the first point-to-point speed enforcement section or a remaining distance of the vehicle in the first point-to-point speed enforcement section.

The method may further include: receiving, based on the vehicle leaving the first point-to-point speed enforcement section and entering a second point-to-point speed enforcement section after completion of the rerouting event, second point-to-point speed enforcement information associated with the second point-to-point speed enforcement section. Controlling the one or more second autonomous driving operations of the vehicle may include: controlling, based on the second point-to-point speed enforcement information, the one or more second autonomous driving operations of the vehicle while the vehicle travels in the second point-to-point speed enforcement section.

The method may further include: storing, in a first buffer of a memory of the vehicle, current point-to-point speed enforcement information associated with a current point-to-point speed enforcement section that the vehicle is traveling in; and storing, in a second buffer of the memory, historical point-to-point speed enforcement information associated with a past point-to-point speed enforcement section that the vehicle has previously traveled in.

The method may further include: initializing the first buffer based on the vehicle not receiving any new point-to-point speed enforcement information within a predetermined time duration after completion of the rerouting event or based on the vehicle receiving new point-to-point speed enforcement information different from the first point-to-point speed enforcement information after completion of the rerouting event.

The method may further include: initializing the second buffer based on the vehicle being in the first point-to-point speed enforcement section after completion of the rerouting event.

The historical point-to-point speed enforcement information may include the first point-to-point speed enforcement information. The method may further include: storing, in the first buffer and based on receiving updated first point-to-point speed enforcement information, at least some of the first point-to-point speed enforcement information stored in the second buffer; and initializing the second buffer.

The first point-to-point speed enforcement information may indicate at least one of: a total distance of the first point-to-point speed enforcement section or a speed limit of the first point-to-point speed enforcement section.

Controlling the one or more first autonomous driving operations of the vehicle may include: identifying a first target speed based on at least one of: the total distance of the first point-to-point speed enforcement section, the speed limit of the first point-to-point speed enforcement section, a covered distance of the vehicle in the first point-to-point speed enforcement section, or an average speed of the vehicle in the first point-to-point speed enforcement section; and controlling a speed of the vehicle such that the vehicle maintains the first target speed before an end point of the first point-to-point speed enforcement section or at a predetermined distance before the end point of the first point-to-point speed enforcement section.

According to one or more example embodiments of the present disclosure, a control device of a vehicle may include: a processor; and a memory storing at least one instruction that is configured, when executed by the processor communicating with the memory, to cause the control device to: receive first point-to-point speed enforcement information associated with a first point-to-point speed enforcement section of a road; control, based on the first point-to-point speed enforcement information, one or more first autonomous driving operations of the vehicle while the vehicle travels in the first point-to-point speed enforcement section; detect a rerouting event associated with the vehicle; determine, based on whether the vehicle is in the first point-to-point speed enforcement section after completion of the rerouting event, whether to reuse the first point-to-point speed enforcement information; and control, based on the determining of whether to reuse the first point-to-point speed enforcement information, one or more second autonomous driving operations of the vehicle.

The at least one instruction may be configured, when executed by the processor communicating with the memory, to further cause the control device to: receive, based on determining that the vehicle is in the first point-to-point speed enforcement section after completion of the rerouting event, updated first point-to-point speed enforcement information associated with a remainder of the first point-to-point speed enforcement section. The updated first point-to-point speed enforcement information may include at least some of the first point-to-point speed enforcement information. The at least one instruction may be configured, when executed by the processor communicating with the memory, to cause the control device to control the one or more second autonomous driving operations of the vehicle by: controlling, based on the updated first point-to-point speed enforcement information, the one or more second autonomous driving operations of the vehicle while the vehicle travels in the remainder of the first point-to-point speed enforcement section.

The updated first point-to-point speed enforcement information may indicate at least one of: a speed limit of the first point-to-point speed enforcement section or a remaining distance of the vehicle in the first point-to-point speed enforcement section.

The at least one instruction may be configured, when executed by the processor communicating with the memory, to further cause the control device to: receive, based on the vehicle leaving the first point-to-point speed enforcement section and entering a second point-to-point speed enforcement section after completion of the rerouting event, second point-to-point speed enforcement information associated with the second point-to-point speed enforcement section. The at least one instruction may be configured, when executed by the processor communicating with the memory, to cause the control device to control the one or more second autonomous driving operations of the vehicle by: controlling, based on the second point-to-point speed enforcement information, the one or more second autonomous driving operations of the vehicle while the vehicle travels in the second point-to-point speed enforcement section.

The memory may include: a first buffer configured to store current point-to-point speed enforcement information associated with a current point-to-point speed enforcement section that the vehicle is traveling in; and a second buffer configured to store historical point-to-point speed enforcement information associated with a past point-to-point speed enforcement section that the vehicle has previously traveled in.

The at least one instruction may be configured, when executed by the processor communicating with the memory, to further cause the control device to: initialize the first buffer based on the vehicle not receiving any new point-to-point speed enforcement information within a predetermined time duration after completion of the rerouting event or based on the vehicle receiving new point-to-point speed enforcement information different from the first point-to-point speed enforcement information after completion of the rerouting event.

The at least one instruction may be configured, when executed by the processor communicating with the memory, to further cause the control device to: initialize the second buffer based on the vehicle being in the first point-to-point speed enforcement section after completion of the rerouting event.

The historical point-to-point speed enforcement information may include the first point-to-point speed enforcement information. The at least one instruction may be configured, when executed by the processor communicating with the memory, to further cause the control device to: store, in the first buffer and based on receiving updated first point-to-point speed enforcement information, at least some of the first point-to-point speed enforcement information stored in the second buffer; and initialize the second buffer.

The first point-to-point speed enforcement information may indicate at least one of: a total distance of the first point-to-point speed enforcement section or a speed limit of the first point-to-point speed enforcement section.

The at least one instruction may be configured, when executed by the processor communicating with the memory, to further cause the control device to: identify a first target speed based on at least one of the total distance of the first point-to-point speed enforcement section, the speed limit of the first point-to-point speed enforcement section, a covered distance of the vehicle in the first point-to-point speed enforcement section, or an average speed of the vehicle in the first point-to-point speed enforcement section; and control a speed of the vehicle such that the vehicle maintains the first target speed before an end point of the first point-to-point speed enforcement section or at a predetermined distance before the end point of the first point-to-point speed enforcement section.

### BRIEF DESCRIPTION OF THE DRAWINGS

The above and other objects, features and advantages of the present disclosure will become more apparent to those of ordinary skill in the art by describing example embodiment(s) thereof in detail with reference to the accompanying drawings, in which:

FIG. 1 is a configuration diagram of a vehicle;

FIG. 2 is a configuration diagram of a storage unit including a first buffer and a second buffer;

FIG. 3 is an exemplary diagram illustrating a point-to-point speed enforcement section;

FIG. 4 is a flowchart of a point-to-point speed enforcement driving strategy;

FIG. 5 is a flowchart of a first point-to-point speed enforcement driving strategy;

FIG. 6 is a flowchart of a second point-to-point speed enforcement driving strategy; and

FIG. 7 is an exemplary diagram of a point-to-point speed enforcement section including a branch point.

### DETAILED DESCRIPTION

Hereinafter, one or more example embodiments of the present disclosure will be described in detail with reference to the accompanying drawings.

However, the technical idea of the present disclosure is not limited to the embodiment(s) that will be described, but may be implemented in various different forms, and one or more of the components in the example embodiment(s) may be selectively combined or substituted and used within the scope of the technical idea of the present disclosure.

Further, terms (including technical and scientific terms) used in the example embodiment(s) of the present disclosure may be construed as having meanings that can be generally understood by those skilled in the art to which the present disclosure belongs, unless explicitly and specifically defined and described, and meanings of terms that are commonly used, such as terms defined in a dictionary, may be construed in consideration of contextual meaning of the related art.

In addition, the terms used in the example embodiment(s) of the present disclosure are intended to describe those embodiment(s) and are not intended to limit the present disclosure.

In the present specification, a singular form may include a plural form unless the context clearly indicates otherwise. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, terms such as “first,” “second,” “A,” “B,” “(a),” and “(b)” may be used to describe components in the example embodiment(s) of the present disclosure.

These terms are only intended to distinguish the component from other components, and do not limit the nature, order, or sequence of the component.

When a component is described as being “connected,” “coupled,” or “joined” to another component, this may include not only a case where the component is directly connected, coupled, or joined to the other component, but also a case where the component is “connected,” “coupled,” or “joined” to the other component by still another component between the component and the other component.

Further, when one component is described as being formed or disposed “on or under” another component, the term “on or under” includes not only a case in which two components are in direct contact with each other, but also a case in which one or more other components are formed or disposed between the two components. In addition, when the term “on or under” is expressed, this may mean not only an upward direction but also a downward direction with respect to one component.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., updating point-to-point speed enforcement zone information after a re-routing event) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., updating point-to-point speed enforcement zone information after a re-routing event) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., updating point-to-point speed enforcement zone information after a re-routing event) described herein.

Minimum risk maneuver (MRM) operation(s) may also be controlled, for example, based on one or more features (e.g., updating point-to-point speed enforcement zone information after a re-routing event) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., updating point-to-point speed enforcement zone information after a re-routing event) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., updating point-to-point speed enforcement zone information after a re-routing event) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., updating point-to-point speed enforcement zone information after a re-routing event) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), etc.). In at least some implementations, an autonomous driving system may receive point-to-point speed enforcement information to adjust a vehicle speed according to a set route and a driving situation. However, when a branching point (e.g., a fork, a Y-intersection, etc.) on a route appears or an unexpected route change occurs, a problem may arise where the point-to-point speed enforcement information is initialized or it is difficult to accurately comply with a speed limit.

In particular, if existing driving information is not inherited at the time of route re-searching (e.g., rerouting, searching for alternative routes, etc.), the existing information may get discarded, making it difficult to reestablish the speed limit.

In various flowcharts of the present disclosure, at least some steps may be omitted or the order of the steps may be changed, and at least some of the various example embodiment(s) of the present disclosure may be performed at a specific point in time in each step of the flowchart. The various flowcharts of the present disclosure may be performed by at least one of a control device 100, a processor 130, and a vehicle 10.

Hereinafter, one or more example embodiments will be described in detail with reference to the accompanying drawings, the same or corresponding components will be denoted by the same reference numbers throughout the drawings, and redundant descriptions thereof will be omitted.

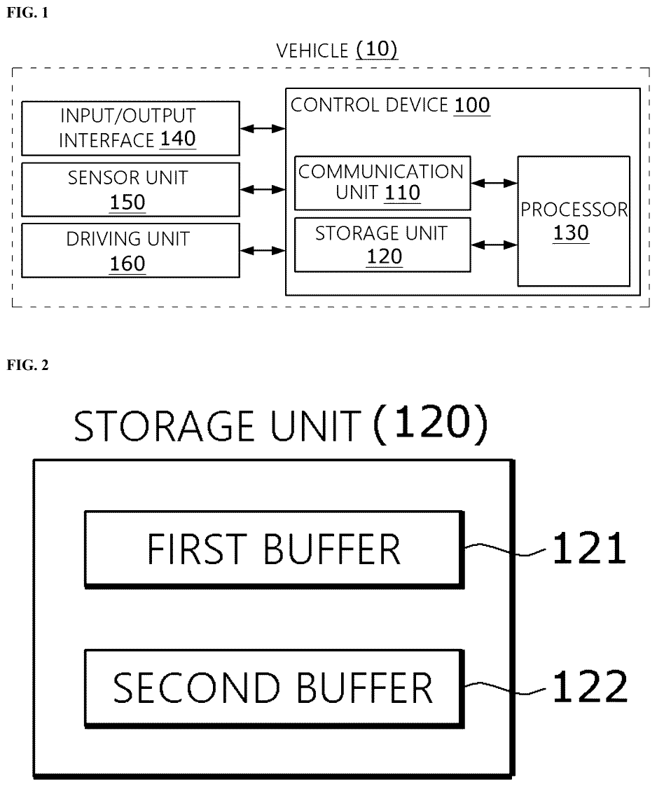

FIG. 1 is a configuration diagram of a vehicle 10.

The vehicle 10 may include a control device 100, a communication unit 110, a storage unit 120, a processor 130, an input/output interface 140, a sensor unit 150, and a driving unit 160. Each of these components of FIG. 1 may be implemented inside the vehicle.

The control device 100 may be formed integrally with internal components of the vehicle, and may be implemented as an independent device separately from the other components inside the vehicle 10 and may perform communication with the internal components of the vehicle through various connection means (e.g., a CAN bus, a wireless network, and a wired connection). The control device 100 may include the communication unit 110, the storage unit 120, and the processor 130 to control the vehicle, and may further include other components such as the input/output interface 140, the sensor unit 150, and the driving unit 160 to perform a complex control function depending on a driving situation.

The control device 100 may receive point-to-point speed enforcement information and rerouting event information from an external network or other components inside the vehicle through the communication unit 110 and determine a driving control strategy by referring to past point-to-point speed enforcement information stored in the storage unit 120 in order to efficiently control the speed of the vehicle in the point-to-point speed enforcement section. A point-to-point speed enforcement section (also referred to as a point-to-point speed enforcement zone, an average speed control section or zone, a section control zone, etc.) may be a section, zone, or stretch of a road (e.g., having a start point and an end point), within which a vehicle is required (e.g., by law) to drive keep an average speed over the entire section at or below a posted speed limit.

In this case, the rerouting may occur not only when route change at a branch point that may occur during automatic driving occurs, but also when the user resets a destination or manually sets a new route through a navigation device.

The communication unit 110 may perform communication with other control devices inside the vehicle to share inter-system data or transmit or receive various types of information through a connection to the outside of the vehicle. The communication unit 110 may transmit control signals and data between the internal components using various in-vehicle communication schemes such as CAN communication and Ethernet, and may link driving information and external data in real time through communication with a user terminal, another vehicle (vehicle-to-vehicle (V2V)), infrastructure (vehicle-to-infrastructure (V2I)), or an external server.

The communication unit 110 may perform short-range communication, global positioning system (GPS) signal reception, vehicle-to-everything (V2X) communication, optical communication, broadcast transmission and reception, and intelligent transport systems (ITS) communication functions, and may support stable data transmission in a short range using wireless communication technology such as Bluetooth, radio frequency identification (RFID), Infrared Data Association (IrDA), ultra wideband (UWB), ZigBee, near field communication (NFC), Wi-Fi, Wi-Fi Direct, and wireless Universal Serial Bus (USB). Further, the communication unit 110 may include a mobile communication module based on a mobile communication network (Long Term Evolution (LTE), 5G, and the like) and a wireless Internet module for access to wireless Internet to receive real-time data through long-range communication and improve the performance of the autonomous driving system in conjunction with a cloud.

The storage unit 120 may include various types of memories capable of storing data, and may be integrated into the control device 100 or the processor 130 or configured in the form of a separate module. The storage unit 120 may include a nonvolatile memory (e.g., a hard disk drive, a flash memory, an electrically erasable programmable read-only memory (EEPROM), an static random-access memory (SRAM), an ferroelectric random-access memory (FRAM), a phase-change random-access memory (PRAM), or magnetoresistive random-access memory (MRAM) and/or a volatile memory (e.g., a dynamic random-access memory (DRAM), a static random-access memory (SDRAM), or a double data rate SDRAM (DDR-SDRAM)), which may be combined to implement memory systems with various capacities and performances.

The storage unit 120 may include a first buffer that stores information on a point-to-point speed enforcement section through which the vehicle is currently driving, and a second buffer that stores past driving information required at the time of rerouting. The first buffer may store point-to-point speed enforcement information (e.g., section distance, speed limit, covered distance, and average speed) required to control the speed of the vehicle in the point-to-point speed enforcement section, and the second buffer may store at least some of the past point-to-point speed enforcement information so that continuous driving control is possible by inheriting existing information at the time of rerouting.

This multi-buffer system enables continuous and flexible driving control so that the vehicle complies with the speed limit in the point-to-point speed enforcement section even in a situation where an unexpected route change or navigation information update occurs during driving. The storage unit 120 may store point-to-point speed enforcement information received from a navigation server when the point-to-point speed enforcement information is provided one time, so that stable control may be achieved within the same point-to-point speed enforcement section even after rerouting.

The processor 130 may perform communication with the communication unit 110, the storage unit 120, the input/output interface 140, the sensor unit 150, the driving unit 160, and various internal components of the vehicle 10 through electrical or operational connections, and may control an operation of each component and perform data processing. The processor 130 is a central processing unit for command execution and data calculation, and may collect, process, and analyze data in real time to perform vehicle control according to a driving environment of the vehicle.

The processor 130 may be implemented in the form of hardware, software, or a combination thereof, and may perform vehicle control logic in the form of, for example, a microcontroller, a field-programmable gate array (FPGA), or an application-specific integrated circuit (ASIC). Further, the processor 130 may include a multi-processor configuration for controlling complex autonomous driving and a driver assistance system.

The input/output interface (also referred to as an input and output interface or a user interface) 140 may serve to receive input related to vehicle control from the user and transfer a vehicle control status and system operation information to the user.

The input/output interface 140 may perform a function of receiving various inputs from the user and transferring the vehicle control status to the user. The input/output interface 140 may include an input means and an output means.

The input means may include physical buttons, soft keys on a touch display, a voice recognition function, a gesture recognition function, and the like, and this allows the user to input commands, for example, to request activation of the autonomous driving system, switch between functions, or set driving assistance.

The output means includes a display, an audio module (e.g., a speaker), a haptic module, and the like, and may provide the user with a status of the autonomous driving system, a control switching request notification, whether or not a function is activated, and the like in a visual, auditory, or tactile form.

The sensor unit 150 may include a plurality of sensors that detect various types of driving and environmental information in real time to support a stable operation of an autonomous driving and driver assistance system. The sensor unit 150 may measure a distance to and speed of a nearby object through long-range detection sensors such as radio detection and ranging (RADAR) and light detection and ranging (LIDAR), and may detect objects near the vehicle 10 by including an ultrasonic sensor.

The sensor unit 150 may include a camera. The camera can be classified into an external camera and an internal camera. The external camera may recognize a road and a surrounding environment, and the internal camera may detect a driver's condition (e.g., eye tracking or drowsiness detection) or an interior situation to comprehensively ascertain situations inside and outside the vehicle. The sensor unit 150 may include a heart rate sensor, a pressure sensor, an infrared sensor, and the like to collect the driver's biometric information or various types of environmental data.

The sensor unit 150 may include sensors for vehicle speed, location information, lane recognition, road slope recognition, traffic signal recognition, sign recognition, and the like in order to continuously monitor a driving state of the vehicle and a surrounding environment within the point-to-point speed enforcement section. These sensors may provide various types of information on conditions of a road on which the vehicle is driving, and a surrounding situation in real time so that the autonomous driving system accurately complies with the speed limit of the point-to-point speed enforcement section.

For example, a GPS sensor may be used to ascertain a current location of the vehicle and recognize the start point and the end point of the point-to-point speed enforcement section, and a lane recognition sensor may support the vehicle so that the vehicle can drive safely while maintaining lanes within the section. Further, a weather sensor or a light sensor that provides information on change in an external environment (e.g., rain or fog) may be included to enable speed adjustment and route selection according to a driving environment.

The driving unit 160 may include various components that provide drive power required for driving of the vehicle 10 and control the operation of the vehicle according to a command output from the control device 100. The driving unit 160 may be configured of devices that generate and transfer power for the vehicle, such as an engine, a motor, a transmission, and a wheel drive system, and a controller that controls the devices, and acceleration, deceleration, and direction change of the vehicle 10 may be performed through such components.

The driving unit 160 is controlled to be able to maintain driving safety by performing longitudinal control (acceleration and deceleration) and lateral control (lane maintenance and change) of the vehicle. For example, the driving unit 160 receives a command from the control device 100 and adjusts an output of the motor or a rotation speed and direction of wheels so that the vehicle can follow the driving path.

Further, the driving unit 160 may include a brake system to reduce a speed of the vehicle or stop the vehicle during driving. The driving unit 160 may control the vehicle 10 based on control through an electric motor in the case of an electric vehicle or based on an engine output in the case of an internal combustion engine vehicle.

The driving unit 160 may adjust the speed of the vehicle within the point-to-point speed enforcement section according to a target speed transferred from the control device 100. The driving unit 160 adjusts the speed of the vehicle so that the vehicle complies with the speed limit of the point-to-point speed enforcement section through acceleration and deceleration, and supports stable and efficient driving.

Further, the driving unit 160 is controlled to perform acceleration, deceleration, and direction change of the vehicle according to a request of a vehicle system (e.g., autonomous driving system) so that the vehicle can follow the driving path.

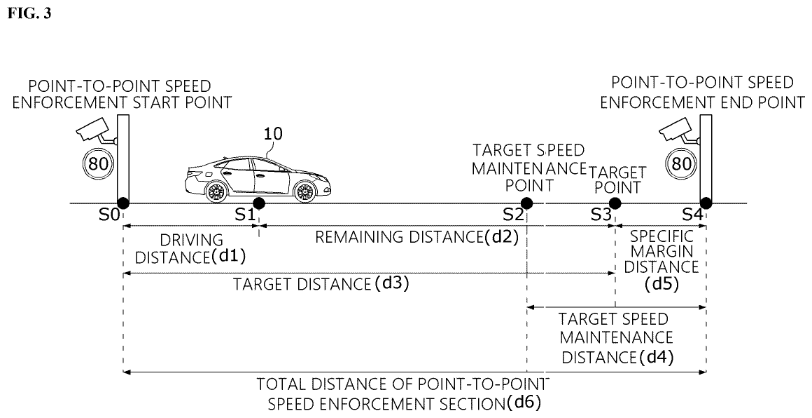

FIG. 2 is a configuration diagram of a storage unit including a first buffer and a second buffer.

The storage unit 120 may include a first buffer 121 and a second buffer 122.

The first buffer 121 may store information on the point-to-point speed enforcement section through which the vehicle is currently driving (e.g., a point-to-point speed enforcement sections that the vehicle is currently traveling in) so that the information can be used to control the speed of the vehicle. Specifically, the first buffer 121 may store information such as the start point (e.g., start point location information such as GPS coordinates) and the end point (e.g., end point location information such as GPS coordinates) of the point-to-point speed enforcement section, the speed limit (e.g., the posted speed limit of the point-to-point speed enforcement section), the covered distance (e.g., the distance that the vehicle has already covered within the point-to-point speed enforcement section), and the average speed (e.g., the average speed of the vehicle for the covered distance of the vehicle), thereby supporting the vehicle so that the vehicle complies with the speed limit within the point-to-point speed enforcement section.

The second buffer 122 may store past point-to-point speed enforcement information for inheriting (e.g., receiving, preserving, etc.) existing (e.g., previous, past, historical, etc.) driving information at the time of rerouting. The second buffer 122 may provide information on an existing (e.g., previous, past, historical, etc.) point-to-point speed enforcement section so that the continuity of driving can be maintained, in a case where the vehicle re-enters a new point-to-point speed enforcement section when a route change occurs. This can allow the vehicle to perform stable speed control even if rerouting takes place.

FIG. 3 is an illustrative diagram illustrating the point-to-point speed enforcement section, and the point-to-point speed enforcement section is a section set to limit the average speed of the vehicle for a certain section. The point-to-point speed enforcement section means a section between a point-to-point speed enforcement start point S0 and a point-to-point speed enforcement end point S4, and a distance from the point-to-point speed enforcement start point S0 to the point-to-point speed enforcement end point S4 may be defined as a total distance d6 of the point-to-point speed enforcement section. Assuming that the vehicle 10 is currently located at a point S1, a covered distance (also referred to as a traveled distance, a driven distance, or a driving distance) d1 is a distance from the point-to-point speed enforcement start point S0 to a current vehicle location S1.

In the point-to-point speed enforcement section, a target speed maintenance point S2 and a target point S3 may be set so that the vehicle can drive at the speed limit. The target speed maintenance point S2 is a point at which the vehicle is required to drive steadily at a target speed until the end point S4 of the point-to-point speed enforcement section. In other words, the speed of the vehicle may be changed until the target speed maintenance point S2, but from this point, the vehicle maintains a constant speed as the target speed and performs constant speed movement until the point-to-point speed enforcement end point S4.

The target point S3 is a point at a specific margin distance d5 before the point-to-point speed enforcement end point S4. The vehicle drives at the target speed from the target speed maintenance point S2 to the point-to-point speed enforcement end point S4 through the target point S3.

A target distance d3 represents a distance from the point-to-point speed enforcement start point S0 to the target point S3, and a remaining distance d2 is defined as a distance obtained by subtracting the covered distance d1 from the target distance d3. A target speed maintenance distance d4 may be a distance from the target speed maintenance point S2 to the point-to-point speed enforcement end point S4, and the specific free distance d5 may be set as a distance from the target point S3 to the point-to-point speed enforcement end point S4. Each of the points and distance information is utilized as a criterion for speed control so that the vehicle can stably comply with the speed limit within the point-to-point speed enforcement section.

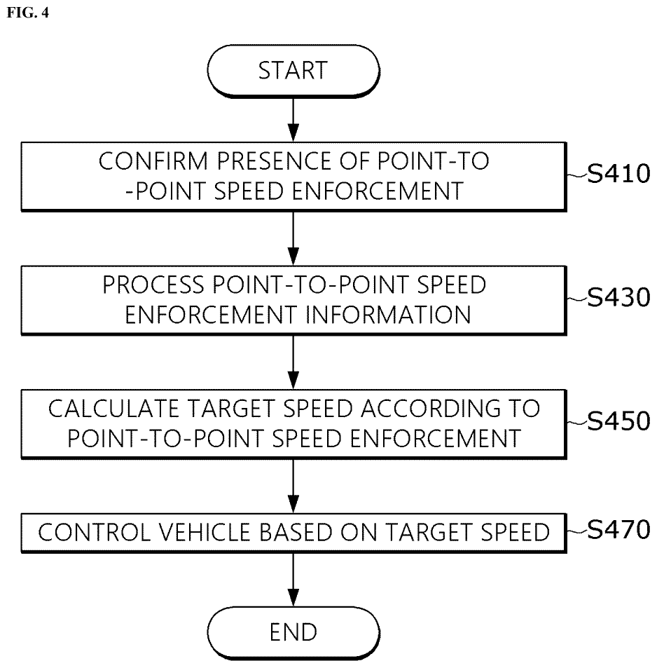

FIG. 4 is a flowchart of a point-to-point speed enforcement driving strategy, and illustrates operations that are performed for the control device 100 to adjust the speed of the vehicle to the speed limit within the point-to-point speed enforcement section.

First, the control device 100 may confirm whether the vehicle has entered the point-to-point speed enforcement section (S410).

Specifically, the control device 100 receives information on a point-to-point speed enforcement section ahead (e.g., the start point, the end point, the speed limit, and a total section distance) from a navigation server (not illustrated) and determines whether the current vehicle location corresponds to the point-to-point speed enforcement section. For example, when the vehicle reaches the point-to-point speed enforcement start point S0, the control device 100 recognizes that the point-to-point speed enforcement section has started, and starts performing the point-to-point speed enforcement driving strategy.

When a determination is made that the point-to-point speed enforcement section has been entered, the control device 100 may process the information on the point-to-point speed enforcement section (S430).

The point-to-point speed enforcement information to be processed here may include a total distance of the point-to-point speed enforcement section, the speed limit, a currently covered distance of the vehicle, a current speed and an average speed of the vehicle, and the like. For example, the control device 100 may calculate a speed change required to adjust the speed when the current speed of the vehicle is higher than the speed limit or when the average speed does not reach the speed limit. Further, when a situation such as rerouting occurs, the control device 100 may determine whether to maintain or update existing point-to-point speed enforcement information to ensure driving continuity within the point-to-point speed enforcement section.

Next, the control device 100 may calculate the target speed for compliance with the speed limit of the point-to-point speed enforcement section (S450).

The control device 100 calculates the target speed so that an average speed of the vehicle at the end point of the point-to-point speed enforcement section reaches the speed limit, and calculates the target speed of the vehicle, in particular, so that the vehicle can drive at a constant speed from the target speed maintenance point S2 to the point-to-point speed enforcement end point S4. For example, the control device 100 calculates an acceleration or deceleration value required within the point-to-point speed enforcement section in consideration of the current location of the vehicle and the speed limit, so that the target speed is reached.

The control device 100 may control the vehicle according to the calculated target speed (S470).

The control device 100 transfers a command to the driving unit 160 so that the vehicle drives through the point-to-point speed enforcement section while maintaining the target speed. For example, the control device 100 may adjust the speed of the vehicle until the vehicle reaches the end point of the first point-to-point speed enforcement section or the target speed maintenance point S2 at a predetermined distance before the end point of the first point-to-point speed enforcement section.

The control device 100 may perform longitudinal control of the vehicle 10 so that the vehicle 10 performs constant speed movement in which the target speed is maintained after the target speed maintenance point S2. This allows the vehicle to consistently comply with the speed limit within the point-to-point speed enforcement section and continue safe driving.

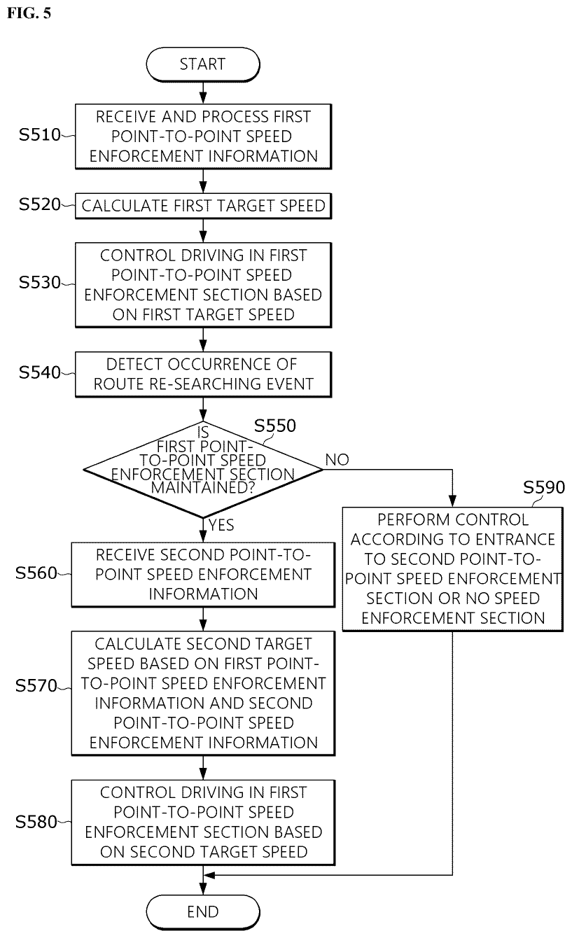

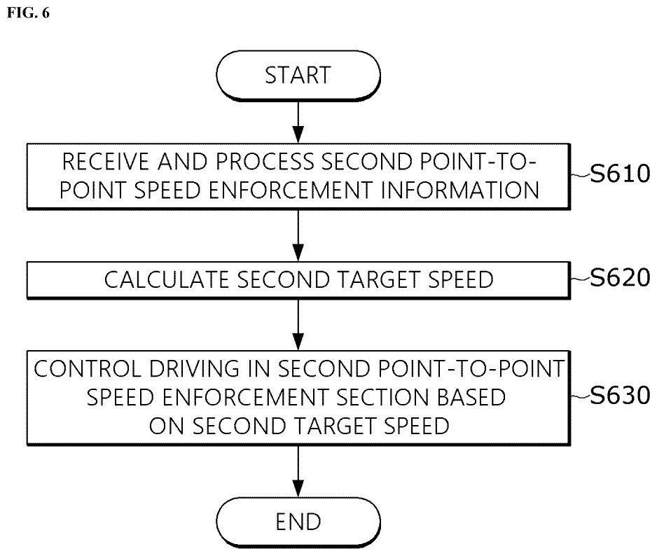

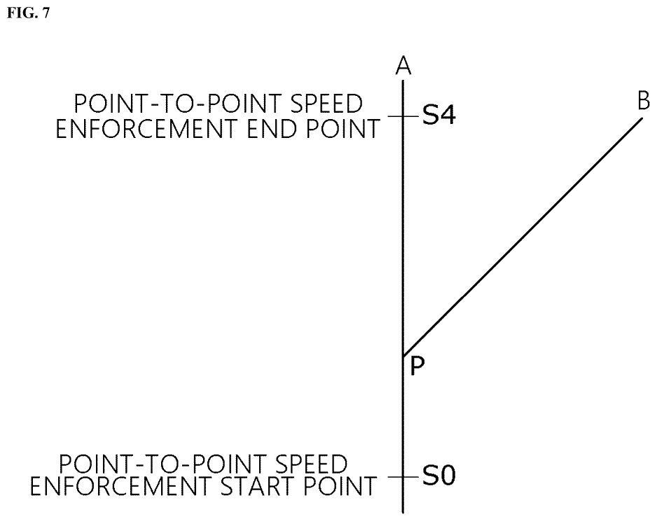

FIG. 5 is a flowchart of a first point-to-point speed enforcement driving strategy. FIG. 7 will be described for description of FIGS. 5 to 6. FIG. 7 illustrates an example of a point-to-point speed enforcement section including a branch point within a point-to-point speed enforcement control strategy.

First, the control device 100 may receive the first point-to-point speed enforcement information of the first point-to-point speed enforcement section and process the received first point-to-point speed enforcement information (S510).

Specifically, the control device 100 may receive the first point-to-point speed enforcement information including information such as the start point, the end point, the speed limit, and the total distance of the point-to-point speed enforcement section from a navigation system or a server. For example, when the vehicle enters a specific road section or enters within a predetermined distance, the control device 100 may receive the first point-to-point speed enforcement information for the section from the navigation server.

The first point-to-point speed enforcement information may be information including various types of data necessary for driving control for the first point-to-point speed enforcement section, and may be provided to support the vehicle so that the vehicle complies with the speed limit. This first point-to-point speed enforcement information may include at least information on the total distance of the first point-to-point speed enforcement section and speed limit information of the first point-to-point speed enforcement section.

The first point-to-point speed enforcement information includes the total distance d6 between the start point S0 and the end point S4 of the first point-to-point speed enforcement section, allowing the control device 100 to ascertain a point at which the vehicle 10 is located. Further, the speed limit of the vehicle within the point-to-point speed enforcement section, for example, a set speed limit value such as 80 km/h or 100 km/h is included. This speed limit serves as a criterion for target speed control so that the vehicle does not exceed the speed limit within the point-to-point speed enforcement section.

Further, the first point-to-point speed enforcement information may include the covered distance d1 that the vehicle has traveled so far, and include a cumulative distance from the start point of the point-to-point speed enforcement section to the current vehicle location. Further, the first point-to-point speed enforcement information may also include the average speed of the vehicle.

The covered distance d1 and the average speed may also be measured and calculated independently through a sensor unit or communication unit of the vehicle 10, rather than from the first point-to-point speed enforcement information. For example, the current location and a movement distance of the vehicle may be confirmed in real time through the GPS or a speed sensor mounted on the sensor unit 150 of the vehicle, and a cumulative covered distance from the start point S0 of the point-to-point speed enforcement section to the current location may be calculated based on the current location and the movement distance.

Further, for the average speed, an average value during a driving time may also be calculated based on speed data provided in the communication unit 110 or the sensor unit 150.

The first point-to-point speed enforcement information is one-time provided information and includes key data required for initial driving control for the first point-to-point speed enforcement section. In particular, information on the total distance d6 of the first point-to-point speed enforcement section is data that is provided only once through the first point-to-point speed enforcement information, and represents a total distance from the start point S0 to the end point S4 of the point-to-point speed enforcement section.

If a situation such as rerouting occurs and updated first point-to-point speed enforcement information is additionally received within the first point-to-point speed enforcement section, the information on the total distance d6 is not included. The updated first point-to-point speed enforcement information includes latest driving control information such as a remaining distance from the current location of the vehicle to the end point S4 of the point-to-point speed enforcement section, and the speed limit, but distance information for the entire section is included only in initial first point-to-point speed enforcement information.

The control device 100 may store the received first point-to-point speed enforcement information in the first buffer 121 and utilize the first point-to-point speed enforcement information as basic information for driving within the point-to-point speed enforcement section.

Further, the control device 100 may store at least some of the first point-to-point speed enforcement information in the second buffer 122 in preparation for subsequent rerouting. The information stored in the second buffer 122 may be total distance information of the first point-to-point speed enforcement section, the speed limit, the average speed of the vehicle, and the like, and may be used to ensure the continuity of the driving by maintaining initial data at the time of returning to the same section after the re-search.

The control device 100 may calculate a first target speed based on the received first point-to-point speed enforcement information (S520).

Specifically, the control device 100 may calculate the first target speed so that the average speed of the vehicle 10 at the end point of the first point-to-point speed enforcement section approaches the speed limit of the first point-to-point speed enforcement section. For example, the control device 100 may calculate the first target speed so that appropriate acceleration or deceleration can be achieved within the section in consideration of the current location of the vehicle, the speed limit, and the covered distance.

Thereafter, the control device 100 may control the driving of the vehicle within the first point-to-point speed enforcement section based on the calculated first target speed (S530).

Specifically, the control device 100 may control the acceleration or deceleration so that the speed of the vehicle reaches the first target speed, and control the driving unit 160 so that the vehicle 10 can drive through the section while maintaining the target speed when the vehicle reaches a first target speed maintenance point. For example, the control device 100 adjusts the speed of the vehicle 10 until the target speed maintenance point, and then the vehicle drives through the point-to-point speed enforcement section while maintaining the first target speed when the vehicle reaches the first target speed.

The control device 100 can detect whether a rerouting event has occurred within the first point-to-point speed enforcement section (S540).

The rerouting event may occur when the driving path of the vehicle needs to be changed due to a branch point or a change in a road situation. For example, rerouting is required in a situation where a driver sets a new destination or a navigation route is changed.

For example, in FIG. 7, the vehicle 10 is driving on a route A, which is a point-to-point speed enforcement section, and may be set to switch to a route B at a junction P on the route depending on a destination. However, a situation where the vehicle 10 continues to drive along the route A instead of switching to the route B at the junction P as expected may occur. In this case, the control device 100 may perform rerouting based on a location of the vehicle 10 at the junction P or an area adjacent thereto.

After rerouting completion, the control device 100 may confirm whether the vehicle is maintaining driving in the first point-to-point speed enforcement section (S550). In other words, the control device 100 may determine whether the vehicle is (e.g., is traveling) still in the first point-to-point speed enforcement section.

When the vehicle is still within the first point-to-point speed enforcement section (S550: Yes), the control device 100 may receive the updated first point-to-point speed enforcement information which is updated point-to-point speed enforcement information from the navigation server (S560).

The point-to-point speed enforcement information may include at least the speed limit information of the first point-to-point speed enforcement section and the remaining distance information of the first point-to-point speed enforcement section.

For example, the updated first point-to-point speed enforcement information may provide driving speed adjustment information according to a remaining section distance and the current location so that the vehicle complies with the speed limit within the first point-to-point speed enforcement section. This allows the control device 100 to adjust the speed of the vehicle based on a remaining distance until the section end point. Further, the control device 100 may confirm whether there is a remaining distance based on the updated first point-to-point speed enforcement information and generate a strategy for driving to the section end.

After rerouting completion, the control device 100 may newly receive the updated first point-to-point speed enforcement information in the first point-to-point speed enforcement section, and store the received updated first point-to-point speed enforcement information in the first buffer 121 as described above. The updated first point-to-point speed enforcement information includes remaining driving information such as a remaining distance for the point-to-point speed enforcement, which allows the control device 100 to adjust the speed of the vehicle 10 based on the remaining distance until the section end point. Further, the control device 100 may confirm whether there is a remaining distance in the updated first point-to-point speed enforcement information and optimize the strategy for driving to the section end.

The control device 100 may calculate an updated first target speed, which is a new target speed, based on the first point-to-point speed enforcement information and the updated first point-to-point speed enforcement information (S570).

In this step, the updated first target speed is calculated so that the vehicle can continue to comply with the speed limit of the point-to-point speed enforcement section. For example, necessary acceleration or deceleration is calculated based on the updated point-to-point speed enforcement information and the current speed of the vehicle, so that the vehicle can drive according to the speed limit.

In this case, the first buffer 121 and the second buffer 122 of the storage unit 120 can provide information according to respective roles, thereby ensuring the accuracy and continuity of the updated first target speed.

Specifically, some of the initial first point-to-point speed enforcement information may be stored in the second buffer 122. For example, the second buffer 122 may store data such as the total distance information of the first point-to-point speed enforcement section and the average speed of the vehicle. Such information is used to continuously refer to initially set point-to-point speed enforcement conditions.

The newly received updated first point-to-point speed enforcement information may be stored in the first buffer 121, and this information may include updated driving conditions such as the remaining distance until the section end point, and the speed limit.

The control device 100 may calculate the updated first target speed by referring to initial point-to-point speed enforcement information in the second buffer 122 and the updated first point-to-point speed enforcement information in the first buffer 121. This allows the vehicle to continuously comply with the speed limit of the point-to-point speed enforcement section.

Total section distance information provided in the first point-to-point speed enforcement information is one-time provided data and is transmitted to the control device 100 only when an initial point-to-point speed enforcement driving strategy is established. Therefore, when existing total section distance information is not stored in the second buffer 122 after rerouting, the control device 100 loses comprehensive distance information for the corresponding point-to-point speed enforcement section.

Therefore, since the total section distance information is information provided one time when the first point-to-point speed enforcement information is received, it may be difficult for the control device 100 to ascertain a distance between the location of the vehicle and the end point when the total section distance information is not obtained again after rerouting.

Accordingly, the control device 100 may have difficulty calculating an optimal target speed so that the vehicle can maintain accurate speed control within the point-to-point speed enforcement section. For example, when the vehicle ascertains only a remaining distance from the current location to the point-to-point speed enforcement end point, there is a limit to setting an acceleration/deceleration strategy through a comparison with a movement distance in the entire section, and as a result, the vehicle is likely not to accurately comply with the speed limit at the point-to-point speed enforcement end point.

Therefore, the control device 100 may store data including at least the entire section distance information provided through the first point-to-point speed enforcement information in the second buffer 122. When the vehicle 10 remains in the same first point-to-point speed enforcement section or when map mapping is performed after rerouting, the control device 100 may cause the first buffer 121 to refer to the data stored in the second buffer 122 or back up the data stored in the second buffer 122 to the first buffer 121. This allows the control device 100 to consistently control the vehicle 10 so that the vehicle converges on the speed limit of the first point-to-point speed enforcement section by inheriting existing information of the first point-to-point speed enforcement section.

After the updated first point-to-point speed enforcement information is received, the control device 100 may initialize (e.g., clear, delete, etc.) the second buffer 122 to perform management so that unnecessary past driving information does not remain. Such an initialization process may allow the second buffer 122 to prepare replacement with new driving information, and to store new information later when necessary.

The control device 100 may control the driving of the vehicle based on the calculated updated first target speed so that the vehicle 10 complies with the speed limit within the first point-to-point speed enforcement section (S580).

For example, the control device 100 may control the vehicle 10 so that the vehicle 10 passes through the point-to-point speed enforcement section while steadily maintaining the speed of the vehicle according to the updated first target speed when the vehicle 10 reaches the target speed maintenance point.

If the vehicle leaves the first point-to-point speed enforcement section after the route re-search completion (S550: No), the control device 100 may control the driving in preparation for entrance to the second point-to-point speed enforcement section or a case where there is no speed enforcement section (S590).

For example, in FIG. 7, when the vehicle 10 moves to the route B at the junction P, the control device 100 may receive new point-to-point speed enforcement information corresponding to the route B to adjust the vehicle speed, or may set the vehicle speed according to general road driving regulations if, for example, the route B is not a point-to-point speed enforcement section.

The control device 100 may initialize the first buffer 121 if, for example, the vehicle does not receive the point-to-point speed enforcement information (e.g., not receive any new point-to-point speed enforcement information) or receives (new) point-to-point speed enforcement information that is different from the first point-to-point speed enforcement information after rerouting completion.

Specifically, if the point-to-point speed enforcement information is not received within a set predetermined time (e.g., time duration) after rerouting, the control device 100 may initialize the first buffer 121. This initialization may mean a state in which the existing driving information is deleted or replaced with other default information when (e.g., at the moment or after) the vehicle leaves the point-to-point speed enforcement section or enters a new section after the re-searching (e.g., rerouting).

Even if the vehicle enters the second point-to-point speed enforcement section different from the first point-to-point speed enforcement section after rerouting completion, the control device 100 may initialize the first buffer 121 to prepare to receive and store information required for a new point-to-point speed enforcement section. This initialization process may prevent confusion due to existing information if the section is changed and/or allow driving control suitable for characteristics of each section to be supported.

In this case, the control device 100 may receive new point-to-point speed enforcement information (e.g., speed limit, section length, start point, and end point) if the route B is a point-to-point speed enforcement section, and the control device 100 may establish a driving strategy for the route B based on the new point-to-point speed enforcement information. On the other hand, if the route B is not the point-to-point speed enforcement section, the control device 100 may perform speed control for compliance with a speed limit regulation, maintenance of a safe speed, and efficient driving. Thus, the vehicle can drive safely and efficiently through consistent driving control despite the route change.

FIG. 6 illustrates a flowchart of a second point-to-point speed enforcement driving strategy, and shows a specific operation of the control device 100 for a situation where the vehicle leaves the first point-to-point speed enforcement section and enters the second point-to-point speed enforcement section in step S590 of FIG. 5.

The control device 100 may receive and process second point-to-point speed enforcement information of the second point-to-point speed enforcement section when the vehicle enters the second point-to-point speed enforcement section (S610).

The second point-to-point speed enforcement information may include key data such as a start point and an end point of the second point-to-point speed enforcement section, a speed limit, and a total distance, and provides information necessary for establishment of a driving strategy for the vehicle within a new point-to-point speed enforcement section.

For example, when the vehicle enters a new road section so that the second point-to-point speed enforcement section is activated, the control device 100 receives the second point-to-point speed enforcement information for this section from a navigation system or an external server. The control device 100 confirms the speed limit, the total distance, and the like of the section from the second point-to-point speed enforcement information, and completes preparations for driving control based on the speed limit, the total distance, and the like.

After the second point-to-point speed enforcement information is processed, the control device 100 may calculate a second target speed by reflecting the speed limit of the point-to-point speed enforcement section and a current driving state (S620).

The second target speed is set so that the average speed of the vehicle at the end point of the second point-to-point speed enforcement section approaches the speed limit of the second point-to-point speed enforcement section, and supports the vehicle so that the vehicle can drive while steadily adjusting the speed within the point-to-point speed enforcement section. For example, the control device 100 compares the current speed of the vehicle with the speed limit of the second point-to-point speed enforcement section to determine whether acceleration or deceleration is required, so that the speed of the vehicle stably reaches the target speed until the end point of the point-to-point speed enforcement section.

Thereafter, the control device 100 may control the vehicle driving in the second point-to-point speed enforcement section based on the calculated second target speed (S630).

Specifically, the control device 100 may transfer a command to the driving unit 160 to adjust acceleration and deceleration so that the vehicle can drive stably without exceeding the speed limit of the second point-to-point speed enforcement section.

For example, the control device 100 performs speed control through the driving unit 160 so that the vehicle drives through the second point-to-point speed enforcement section while maintaining a constant speed according to the target speed. This allows the vehicle to continue to drive stably and efficiently while maintaining speed limit compliance from the start point to the end point of the second point-to-point speed enforcement section.

Thus, when the vehicle leaves the first point-to-point speed enforcement section and enters the second point-to-point speed enforcement section, the control device 100 may perform a series of processes of processing information on a new section, calculating a target speed for performing point-to-point speed enforcement control, and then controlling driving while maintaining the target speed.

According to an aspect of the present disclosure, there is provided a method for controlling a vehicle, including: receiving first point-to-point speed enforcement information related to a first point-to-point speed enforcement section; controlling driving in the first point-to-point speed enforcement section based on the first point-to-point speed enforcement information; detecting occurrence of a route re-searching event; and determining whether to reuse the first point-to-point speed enforcement information depending on whether the vehicle maintains the driving in the first point-to-point speed enforcement section after route re-searching completion.

The method according to some aspects may further includes: receiving (1-1)-th point-to-point speed enforcement information including at least some of the first point-to-point speed enforcement information when the vehicle maintains the driving in the first point-to-point speed enforcement section after route re-searching completion; and controlling the driving in the first point-to-point speed enforcement section based on the at least some of the first point-to-point speed enforcement information and at least some of the (1-1)-th point-to-point speed enforcement information.

The method according to some aspects may further include receiving second point-to-point speed enforcement information related to a second point-to-point speed enforcement section when the vehicle leaves the first point-to-point speed enforcement section and enters the second point-to-point speed enforcement section after route re-searching completion; and controlling driving in the second point-to-point speed enforcement section based on the second point-to-point speed enforcement information.

In the method according to some aspects, a memory of the vehicle may include a first buffer configured to store information for driving control in a point-to-point speed enforcement section through which the vehicle currently drives; and a second buffer configured to store information in a point-to-point speed enforcement section through which the vehicle has previously driven.

In the method according to some aspects, the first buffer may be set to be initialized when point-to-point speed enforcement information is not received within a predetermined time after route re-searching completion or when the vehicle receives the second point-to-point speed enforcement information different from the first point-to-point speed enforcement information after route re-searching completion.

In the method according to some aspects, the second buffer may be set to be initialized when the vehicle maintains the driving in the first point-to-point speed enforcement section after route re-searching completion.

The method according to some aspects may further include storing, in the first buffer, some of the first point-to-point speed enforcement information stored in the second buffer upon receiving the (1-1)-th point-to-point speed enforcement information; and initializing the second buffer.

In the method according to some aspects, the first point-to-point speed enforcement information may include at least total distance information of the first point-to-point speed enforcement section and speed limit information of the first point-to-point speed enforcement section.

In the method according to some aspects, the (1-1)-th point-to-point speed enforcement information may include at least speed limit information of the first point-to-point speed enforcement section and remaining distance information of the first point-to-point speed enforcement section.

In the method according to some aspects, the controlling of the driving in the first point-to-point speed enforcement section based on the first point-to-point speed enforcement information may include: calculating a first target speed based on at least one of the total distance information of the first point-to-point speed enforcement section, the speed limit information of the first point-to-point speed enforcement section, a driving distance of the vehicle, and an average speed of the vehicle; and controlling the speed of the vehicle so that the vehicle maintains the first target speed before an end point of the first point-to-point speed enforcement section or at a predetermined distance before the end point of the first point-to-point speed enforcement section.

According to another aspect of the present disclosure, there is provided a control device including a memory; and a processor electrically or adaptively connected to the memory, wherein the processor is configured to receive first point-to-point speed enforcement information related to a first point-to-point speed enforcement section set to limit an average speed of a vehicle in a predetermined section, control driving in the first point-to-point speed enforcement section based on the first point-to-point speed enforcement information, detect occurrence of a route re-searching event, and determine whether to reuse the first point-to-point speed enforcement information depending on whether the vehicle maintains the driving in the first point-to-point speed enforcement section after route re-searching completion.

In the control device according to some aspects, when the vehicle maintains the driving in the first point-to-point speed enforcement section after route re-searching completion, the processor may be configured to receive (1-1)-th point-to-point speed enforcement information including at least some of the first point-to-point speed enforcement information, and control the driving in the first point-to-point speed enforcement section based on the at least some of the first point-to-point speed enforcement information and at least some of the (1-1)-th point-to-point speed enforcement information.

In the control device according to some aspects, when the vehicle leaves the first point-to-point speed enforcement section and enters a second point-to-point speed enforcement section after route re-searching completion, the processor may be configured to receive second point-to-point speed enforcement information related to the second point-to-point speed enforcement section and control driving in the second point-to-point speed enforcement section based on the second point-to-point speed enforcement information.

In the control device according to some aspects, the memory may include a first buffer configured to store information for driving control in a point-to-point speed enforcement section through which the vehicle currently drives; and a second buffer configured to store information in a point-to-point speed enforcement section through which the vehicle has previously driven.

In the control device according to some aspects, the processor may be configured to initialize the first buffer when point-to-point speed enforcement information is not received within a predetermined time after route re-searching completion or when the vehicle receives the second point-to-point speed enforcement information different from the first point-to-point speed enforcement information after route re-searching completion.

In the control device according to some aspects, the processor may be configured to initialize the second buffer when the vehicle maintains the driving in the first point-to-point speed enforcement section after route re-searching completion.

In the control device according to some aspects, the processor may be configured to store, in the first buffer, some of the first point-to-point speed enforcement information stored in the second buffer upon receiving the (1-1)-th point-to-point speed enforcement information, and initialize the second buffer.

In the control device according to some aspects, the first point-to-point speed enforcement information may include at least total distance information of the first point-to-point speed enforcement section and speed limit information of the first point-to-point speed enforcement section.

In the control device according to some aspects, the (1-1)-th point-to-point speed enforcement information may include at least speed limit information of the first point-to-point speed enforcement section and remaining distance information of the first point-to-point speed enforcement section.

In the control device according to some aspects, the processor may be configured to calculate a first target speed based on at least one of the total distance information of the first point-to-point speed enforcement section, the speed limit information of the first point-to-point speed enforcement section, a driving distance of the vehicle, and an average speed of the vehicle; and control the speed of the vehicle so that the vehicle maintains the first target speed before an end point of the first point-to-point speed enforcement section or at a predetermined distance before the end point of the first point-to-point speed enforcement section.

The term “unit” used in the example embodiment(s) may refer to a software or hardware component such as a field-programmable gate array (FPGA) or an ASIC, and a “unit” performs a certain role. However, a “unit” is not limited to software or hardware. A “unit” may be configured to reside on an addressable storage medium or may be configured to operate one or more processors. Accordingly, for example, “unit” includes components such as software components, object-oriented software components, class components, and task components, processes, functions, attributes, procedures, subroutines, segments of program code, drivers, firmware, microcode, circuits, data, databases, data structures, tables, arrays, and variables. Functions provided in the components and the “units” may be combined into a smaller number of components and “units” or may be further separated into additional components and “units.” In addition, the components and “units” may be implemented to operate one or more CPUs in a device or a secure multimedia card.

According to the present disclosure, even if rerouting occurs, existing driving information is inherited and the continuity of the point-to-point speed enforcement information is maintained in a case where the vehicle is in the same point-to-point speed enforcement section, so that the vehicle can consistently comply with the speed limit of the point-to-point speed enforcement section.

The effects of the present disclosure are not limited to the effect mentioned above, and other effects that have not been mentioned can be clearly understood by those skilled in the art from the description below.

Although the present disclosure has been described above with reference to one or more example embodiments of the present disclosure, it will be understood by those skilled in the art that various modifications and changes can be made to the present disclosure without departing from the spirit and scope of the present disclosure set forth in the following claims.

What is claimed is:

1. A method performed by an apparatus of a vehicle, the method comprising:
receiving first point-to-point speed enforcement information associated with a first point-to-point speed enforcement section of a road;
controlling, based on first the point-to-point speed enforcement information, one or more first autonomous driving operations of the vehicle while the vehicle travels in the first point-to-point speed enforcement section;
detecting a rerouting event associated with the vehicle;
determining, based on whether the vehicle is in the first point-to-point speed enforcement section after completion of the rerouting event, whether to reuse the first point-to-point speed enforcement information; and
controlling, based on the determining of whether to reuse the first point-to-point speed enforcement information, one or more second autonomous driving operations of the vehicle.

2. The method of claim 1, further comprising:
receiving, based on determining that the vehicle is in the first point-to-point speed enforcement section after completion of the rerouting event, updated first point-to-point speed enforcement information associated with a remainder of the first point-to-point speed enforcement section, wherein the updated first point-to-point speed enforcement information comprises at least some of the first point-to-point speed enforcement information,
wherein the controlling of the one or more second autonomous driving operations of the vehicle comprises:
controlling, based on the updated first point-to-point speed enforcement information, the one or more second autonomous driving operations of the vehicle while the vehicle travels in the remainder of the first point-to-point speed enforcement section.

3. The method of claim 2, wherein the updated first point-to-point speed enforcement information indicates at least one of: a speed limit of the first point-to-point speed enforcement section or a remaining distance of the vehicle in the first point-to-point speed enforcement section.

4. The method of claim 1, further comprising:
receiving, based on the vehicle leaving the first point-to-point speed enforcement section and entering a second point-to-point speed enforcement section after completion of the rerouting event, second point-to-point speed enforcement information associated with the second point-to-point speed enforcement section,
wherein the controlling of the one or more second autonomous driving operations of the vehicle comprises:
controlling, based on the second point-to-point speed enforcement information, the one or more second autonomous driving operations of the vehicle while the vehicle travels in the second point-to-point speed enforcement section.

5. The method of claim 1, further comprising:
storing, in a first buffer of a memory of the vehicle, current point-to-point speed enforcement information associated with a current point-to-point speed enforcement section that the vehicle is traveling in; and
storing, in a second buffer of the memory, historical point-to-point speed enforcement information associated with a past point-to-point speed enforcement section that the vehicle has previously traveled in.

6. The method of claim 5, further comprising:
initializing the first buffer based on the vehicle not receiving any new point-to-point speed enforcement information within a predetermined time duration after completion of the rerouting event or based on the vehicle receiving new point-to-point speed enforcement information different from the first point-to-point speed enforcement information after completion of the rerouting event.

7. The method of claim 5, further comprising:
initializing the second buffer based on the vehicle being in the first point-to-point speed enforcement section after completion of the rerouting event.

8. The method of claim 5, wherein the historical point-to-point speed enforcement information comprises the first point-to-point speed enforcement information, and wherein the method further comprises:
storing, in the first buffer and based on receiving updated first point-to-point speed enforcement information, at least some of the first point-to-point speed enforcement information stored in the second buffer; and
initializing the second buffer.

9. The method of claim 1, wherein the first point-to-point speed enforcement information indicates at least one of: a total distance of the first point-to-point speed enforcement section or a speed limit of the first point-to-point speed enforcement section.

10. The method of claim 9, wherein the controlling of the one or more first autonomous driving operations of the vehicle comprises:
identifying a first target speed based on at least one of: the total distance of the first point-to-point speed enforcement section, the speed limit of the first point-to-point speed enforcement section, a covered distance of the vehicle in the first point-to-point speed enforcement section, or an average speed of the vehicle in the first point-to-point speed enforcement section; and
controlling a speed of the vehicle such that the vehicle maintains the first target speed before an end point of the first point-to-point speed enforcement section or at a predetermined distance before the end point of the first point-to-point speed enforcement section.

11. A control device of a vehicle, the control device comprising:
a processor; and
a memory storing at least one instruction that is configured, when executed by the processor communicating with the memory, to cause the control device to:
receive first point-to-point speed enforcement information associated with a first point-to-point speed enforcement section of a road;
control, based on the first point-to-point speed enforcement information, one or more first autonomous driving operations of the vehicle while the vehicle travels in the first point-to-point speed enforcement section;
detect a rerouting event associated with the vehicle;
determine, based on whether the vehicle is in the first point-to-point speed enforcement section after completion of the rerouting event, whether to reuse the first point-to-point speed enforcement information; and
control, based on the determining of whether to reuse the first point-to-point speed enforcement information, one or more second autonomous driving operations of the vehicle.

12. The control device of claim 11, wherein the at least one instruction is configured, when executed by the processor communicating with the memory, to further cause the control device to:
receive, based on determining that the vehicle is in the first point-to-point speed enforcement section after completion of the rerouting event, updated first point-to-point speed enforcement information associated with a remainder of the first point-to-point speed enforcement section, wherein the updated first point-to-point speed enforcement information comprises at least some of the first point-to-point speed enforcement information, and
wherein the at least one instruction is configured, when executed by the processor communicating with the memory, to cause the control device to control the one or more second autonomous driving operations of the vehicle by:
controlling, based on the updated first point-to-point speed enforcement information, the one or more second autonomous driving operations of the vehicle while the vehicle travels in the remainder of the first point-to-point speed enforcement section.

13. The control device of claim 12, wherein the updated first point-to-point speed enforcement information indicates at least one of: a speed limit of the first point-to-point speed enforcement section or a remaining distance of the vehicle in the first point-to-point speed enforcement section.

14. The control device of claim 11, wherein the at least one instruction is configured, when executed by the processor communicating with the memory, to further cause the control device to:
receive, based on the vehicle leaving the first point-to-point speed enforcement section and entering a second point-to-point speed enforcement section after completion of the rerouting event, second point-to-point speed enforcement information associated with the second point-to-point speed enforcement section, and
wherein the at least one instruction is configured, when executed by the processor communicating with the memory, to cause the control device to control the one or more second autonomous driving operations of the vehicle by:
controlling, based on the second point-to-point speed enforcement information, the one or more second autonomous driving operations of the vehicle while the vehicle travels in the second point-to-point speed enforcement section.

15. The control device of claim 11, wherein the memory comprises:
a first buffer configured to store current point-to-point speed enforcement information associated with a current point-to-point speed enforcement section that the vehicle is traveling in; and
a second buffer configured to store historical point-to-point speed enforcement information associated with a past point-to-point speed enforcement section that the vehicle has previously traveled in.

16. The control device of claim 15, wherein the at least one instruction is configured, when executed by the processor communicating with the memory, to further cause the control device to:
initialize the first buffer based on the vehicle not receiving any new point-to-point speed enforcement information within a predetermined time duration after completion of the rerouting event or based on the vehicle receiving new point-to-point speed enforcement information different from the first point-to-point speed enforcement information after completion of the rerouting event.

17. The control device of claim 15, wherein the at least one instruction is configured, when executed by the processor communicating with the memory, to further cause the control device to:
initialize the second buffer based on the vehicle being in the first point-to-point speed enforcement section after completion of the rerouting event.

18. The control device of claim 15, wherein the historical point-to-point speed enforcement information comprises the first point-to-point speed enforcement information, and wherein the at least one instruction is configured, when executed by the processor communicating with the memory, to further cause the control device to:
store, in the first buffer and based on receiving updated first point-to-point speed enforcement information, at least some of the first point-to-point speed enforcement information stored in the second buffer; and
initialize the second buffer.

19. The control device of claim 11, wherein the first point-to-point speed enforcement information indicates at least one of: a total distance of the first point-to-point speed enforcement section or a speed limit of the first point-to-point speed enforcement section.

20. The control device of claim 19, wherein the at least one instruction is configured, when executed by the processor communicating with the memory, to further cause the control device to:
identify a first target speed based on at least one of the total distance of the first point-to-point speed enforcement section, the speed limit of the first point-to-point speed enforcement section, a covered distance of the vehicle in the first point-to-point speed enforcement section, or an average speed of the vehicle in the first point-to-point speed enforcement section; and
control a speed of the vehicle such that the vehicle maintains the first target speed before an end point of the first point-to-point speed enforcement section or at a predetermined distance before the end point of the first point-to-point speed enforcement section.
